(19) United States
(12) Patent Application Publication
(10) Pub. No.: US 2002/0021922 A1
(43) Pub. Date: Feb. 21, 2002

(54) Method and apparatus for applying dry lubricant

(76) Inventors: Takahiro Katoh, Aomori (JP); Kiyoshi Kogawa, Aomori (JP); Bunsei Miyamoto, Aomori (JP)

Correspondence Address: FITZPATRICK CELLA HARPER & SCINTO, 30 ROCKEFELLER PLAZA, NEW YORK, NY, 10112, US

(21) Appl. No.: 09/906,818

(22) Filed: Jul. 18, 2001

(30) Foreign Application Priority Data
Jul. 25, 2000 (JP) 224363/2000
Dec. 1, 2000 (JP) 366673/2000
May 23, 2001 (JP) 153834/2001

(51) Int. Cl. G03G 21/00

(52) U.S. Cl. 399/346

(57) ABSTRACT

Powdery dry lubricant is applied to the surface of a sliding member to be used with a copying machine, a printer or a facsimile machine operating on the basis of electrophotography, in place of toner particles in order to conduct various tests during the assembling process of those machines. Such dry lubricant is applied to a sliding member such as developing sleeve, developing blade, photosensitive drum or developing agent recovering blade, by 1) charging the dry lubricant contained in a container having an opening with electricity, 2) supplying air to the container to eject the electrically charged dry lubricant from the opening toward the sliding member that is grounded and secured as separate from the opening, and 3) causing the dry lubricant ejected from the opening to be adsorbed by the sliding member by means of electrostatic force.

### BACKGROUND OF THE INVENTION

1. Field of the Invention

This invention relates to a method and an apparatus for applying dry lubricant. More particularly, the present invention relates to a method and an apparatus for applying dry lubricant to a sliding member (e.g., a developing agent recovering blade abutting a photosensitive drum, a developing blade abutting a developing sleeve or the like) of an electrophotographic image forming apparatus in order to conduct various tests during the assembling process.

2. Related Background Art

Image forming apparatus including copying machines, printers and facsimile machines adapted to form images on the basis of electrophotography are provided with a developing agent recovering blade for removing the toner remaining on the photosensitive drum after an image transfer operation by abutting and scraping the photosensitive drum and a developing blade for controlling the thickness of the layer of the developing agent applied to the surface of the developing sleeve by abutting and sliding on the surface of the developing sleeve.

Such image forming apparatus are subjected to a series of tests including a mock image characteristics test for verifying the image quality of the images to be produced from the apparatus in actual use. The tests are normally conducted during the assembling process in the manufacturing plant. The developing unit of the apparatus is provided with a developing agent shielding seal applied thereto during all the assembling process down to the time of shipment in order to block any supply of developing agent to the developing unit because the apparatus becomes a used one once the developing agent (toner) is fed to the developing unit if for the purpose of testing.

Then, the developing agent recovering blade and the developing blade directly touch the photosensitive drum and the developing sleeve respectively without any developing agent interposed therebetween to consequently give rise to problems such as a ‘warped’ developing agent recovering blade, a ‘warped’ developing blade, a ‘dented’ contact surface of the photosensitive drum and a ‘scraped’ contact area of the developing sleeve. Conventionally, liquid lubricant obtained by mixing dry lubricant with inert liquid or solvent or electrically charged dry lubricant is applied to the surface of the developing agent recovering blade and that of the developing blade in order to prevent these problems from taking place.

Techniques that have been used for applying liquid lubricant or dry lubricant to the developing agent recovering blade and the developing blade include those listed in (a) through (d) below.

(a) Referring to FIGS. 1A through 1C of the accompanying drawings, the mixture of liquid (or pasty) lubricant 21 and inert liquid or solvent in the container 20 is sucked by means of a quantitative ejector 22 and the sucked liquid lubricant is applied onto the surface of the sliding member (the developing agent recovering blade or the developing blade) 23 of the image forming apparatus by quantitatively ejecting the mixture through a nozzle 22a, while moving the sliding member at a constant rate. Subsequently, the inert liquid or the solvent in the mixture is forced to evaporate and the liquid lubricant 21 is dried on the surface of the sliding member 23 to become dried liquid lubricant 21a.

(b) As shown in FIGS. 2A through 2D of the accompanying drawings, the dry lubricant 24 in the container 20 is made to adhere to an electrically charged member 25. Then, the electrically charged member 25 now carrying the dry lubricant 24 adhering thereto is brought to contact with the surface of the sliding member (the developing agent recovering blade or the developing blade) 23 of the image forming apparatus that is driven to rotate and the electrically charged member 25 is made to slide longitudinally on the sliding member 23. As a result, the dry lubricant 24 located between the electrically charged member 25 and the sliding member 23 becomes electrically charged by friction to give rise to a potential difference between the sliding member 23 that is grounded and the dry lubricant 24. Thus, the applied dry lubricant 24 adheres to the surface of the sliding member 23.

(c) Referring now to FIGS. 3A through 3D of the accompanying drawings, an electrically charged member 25 is driven to frictionally slide in the dry lubricant 24 in the container 20 until the dry lubricant 24 becomes electrically charged by friction. Then, the electrically charged member 25 now carrying the dry lubricant 24 adhering thereto is brought to contact with the surface of the sliding member (the developing agent recovering blade or the developing blade) 23 of the image forming apparatus that is grounded and driven to rotate. As a result, the dry lubricant 24 located between the electrically charged member 25 and the sliding member 23 becomes electrically charged by friction to give rise to a potential difference between the sliding member 23 that is grounded and the dry lubricant 24. Thus, the applied dry lubricant 24 adheres to the surface of the sliding member 23.

(d) As shown in FIGS. 4A and 4B of the accompanying drawings, the dry lubricant 24 in the container 20 is made to adhere to an electrically charged roller 26 that is driven to rotate. Then, the electrically charged roller 26 now carrying the dry lubricant 24 adhering thereto is brought to contact with the surface of the sliding member (the developing agent recovering blade or the developing blade) 23 of the image forming apparatus that is driven to rotate so that the electrically charged roller 26 may slide (slip) and rotate on the sliding member 23. As a result, the dry lubricant 24 located between the electrically charged roller 26 and the sliding member 23 becomes electrically charged by friction to give rise to a potential difference between the sliding member 23 that is grounded and the dry lubricant 24. Thus, the applied dry lubricant 24 adheres to the surface of the sliding member 23.

However, the method of applying liquid lubricant (a) described above by referring to FIGS. 1A through 1C is accompanied by the problems listed (1) through (8) below.

(1) The operation of preparing the liquid lubricant 21 is a cumbersome one because dry lubricant has to be mixed with inert liquid or solvent.

(2) Inert liquid substances are very costly and normally show a very high globe warming coefficient. Therefore, they may no longer be allowed to be used for preparing liquid lubricant 21. The use of some of them is already restricted.

(3) Solvents that can be used for preparing liquid lubricant 21 include dangerous substances (alcohol and petroleum). Therefore, the greatest possible care needs to be taken for handling such solvents.

(4) Since the liquid lubricant 21 left in the container 20 after use is disposed as liquid waste, it is difficult to recover and reuse it (a liquid lubricant recovery system is costly).

(5) The method comprises a drying step for drying the liquid lubricant 21 applied to the surface of the sliding member 23, which is a time consuming step.

(6) It is normally very difficult to produce a uniformly applied layer of liquid lubricant 21 by applying the liquid lubricant 21 onto the surface of the sliding member 23 by means of a quantitative ejector 22, causing the inert liquid or the solvent to evaporate from the liquid lubricant 21 in a drying step and forming a layer of the dried liquid lubricant 21a on the surface of the sliding member 23.

(7) Agglomerates of particles of the liquid lubricant 21 are normally formed when preparing the liquid lubricant 21 by mixing dry lubricant with inert liquid or solvent. As a result, micro-undulations and coarse surface areas can be produced on the applied surface of the sliding member 23.

(8) As the liquid lubricant 21 is applied to the surface of the sliding member 23 by means of the quantitative ejector 22 and subsequently dried, a layer of the dried liquid lubricant 21a is formed on the surface of the sliding member 23. As shown in FIGS. 5A through 5D, as the rotating developing sleeve 28 touches and slides on the layer of the dried liquid lubricant 21a (see FIGS. 5A and 5B) formed on the surface of the sliding member 27, which is the developing sleeve, the layer of the dried liquid lubricant 21a is deformed to show a inwardly curved surface (see FIG. 5C). Thus, when the user uses the image forming apparatus shipped from the plant and comprising the developing blade 27 and the developing sleeve 28, he or she will find that the developing agent (toner) is not supplied reliably at a constant rate in the developing step because of the dried liquid lubricant 21a that is located between the developing blade 27 and the developing sleeve 28 and shows an inwardly curved surface and consequently the image quality of the produced image is not high (see FIG. 5D).

On the other hand, with the method of applying dry lubricant described in (b) above by referring to FIGS. 2A through 2D, while an electric charge is generated by friction in the dry lubricant 24 interposed between the electrically charged member 25 and the sliding member 23, the particles of the dry lubricant 24 are not electrically charged by friction to a satisfactory extent and hence the relative potential difference between the sliding member 23 and the dry lubricant 24 is low. Therefore, the dry lubricant 24 is not sufficiently fixed and can come off from the surface of the sliding member 23. Consequently, the dry lubricant 24 is not reliably applied to the surface of the sliding member 23 to show a uniform thickness. Additionally, as the electrically charged member 25 carrying the dry lubricant 24 adhering thereto is made to touch and slide on the sliding member 23, the sliding member 23 can be damaged by the sliding motion of the charged member 25.

The same is true with the method of applying dry lubricant described in (c) above by referring to FIGS. 3A through 3D. While an electric charge is generated by friction in the dry lubricant 24 interposed between the electrically charged member 25 and the sliding member 23, the particles of the dry lubricant 24 are not electrically charged by friction to a satisfactory extent and hence the relative potential difference between the sliding member 23 and the dry lubricant 24 is low. Therefore, the dry lubricant 24 is not sufficiently fixed and can come off from the surface of the sliding member 23. Consequently, the dry lubricant 24 is not reliably applied to the surface of the sliding member 23 to show a uniform thickness. Additionally, as the electrically charged member 25 carrying the dry lubricant 24 adhering thereto is made to touch the sliding member 23, the sliding member 23 can be damaged by the touching motion of the charged member 25.

Again, with the method of applying dry lubricant described in (d) above by referring to FIGS. 4A and 4B. While an electric charge is generated by friction in the dry lubricant 24 interposed between the electrically charged roller 26 and the sliding member 23, the particles of the dry lubricant 24 are not electrically charged by friction to a satisfactory extent and hence the relative potential difference between the sliding member 23 and the dry lubricant 24 is low. Therefore, the dry lubricant 24 is not sufficiently fixed and can come off from the surface of the sliding member 23. Consequently, the dry lubricant 24 is not reliably applied to the surface of the sliding member 23 to show a uniform thickness. Additionally, as the electrically charged roller 26 carrying the dry lubricant 24 adhering thereto is made to touch and slide on the sliding member 23, the sliding member 23 can be damaged by the sliding rotation of the charged roller 26.

### SUMMARY OF THE INVENTION

Therefore, the object of the present invention is to solve the above identified problems of the prior art by providing a method and an apparatus for applying dry lubricant uniformly and reliably onto an object of application in a simple manner without damaging the object of application.

In an aspect of the invention, the above object is achieved by providing a method for applying dry lubricant comprising the steps of:

charging the dry lubricant contained in a container having an opening with electricity;

supplying air to said container and ejecting the electrically charged dry lubricant from said opening toward an object of application grounded and separated from said opening by a predetermined distance; and

causing the dry lubricant ejected from said opening to be adsorbed by said object of application by means of electrostatic force.

In another aspect of the invention, there is provided an apparatus for applying dry lubricant comprising:

a container having an opening and containing dry lubricant;

an electrically charging means for charging the dry lubricant contained in said container with electricity; and

an air supply means for ejecting the electrically charged dry lubricant from said opening toward an object of application grounded and separated from said opening by a predetermined distance by supplying air to said container.

### BRIEF DESCRIPTION OF THE DRAWINGS

FIGS. 1A, 1B and 1C are schematic illustrations of a first known method for applying lubricant, which is liquid lubricant.

FIGS. 2A, 2B, 2C and 2D are schematic illustrations of a second known method for applying lubricant, which is dry lubricant.

FIGS. 3A, 3B, 3C and 3D are schematic illustrations of a third known method for applying lubricant, which is dry lubricant.

FIGS. 4A and 4B are schematic illustrations of a fourth known method for applying lubricant, which is dry lubricant.

FIGS. 5A, 5B, 5C and 5D are schematic illustrations of some of the problems of known methods for applying liquid lubricant.

FIG. 6 is a schematic block diagram of a first embodiment of apparatus for applying dry lubricant according to the invention.

FIG. 7 is a schematic cross sectional view of a process cartridge that can be removably fitted to an electrophotographic image forming apparatus.

FIG. 8 is a schematic block diagram of a second embodiment of apparatus for applying dry lubricant according to the invention and adapted to apply lubricant to a developing sleeve.

FIG. 9 is a schematic illustration of a developing blade abutting a developing sleeve carrying dry lubricant applied thereto.

FIG. 10 is a schematic block diagram of a third embodiment of apparatus for applying dry lubricant according to the invention and adapted to apply lubricant to a photosensitive drum.

FIG. 11 is a schematic illustration of a developing agent recovering blade abutting a photosensitive drum carrying dry lubricant applied thereto.

FIG. 12 is a schematic block diagram of a fourth embodiment of apparatus for applying dry lubricant according to the invention and adapted to apply lubricant to a developing blade.

FIG. 13 is a schematic illustration of a developing blade carrying dry lubricant applied thereto and abutting a developing sleeve.

FIG. 14 is a schematic block diagram of a fifth embodiment of apparatus for applying dry lubricant according to the invention and adapted to apply lubricant to a developing agent recovering blade.

FIG. 15 is a schematic illustration of a developing agent recovering blade carrying dry lubricant applied thereto and abutting a photosensitive drum.

FIG. 16 is a schematic block diagram of a sixth embodiment of apparatus for applying dry lubricant.

FIG. 17 is a schematic block diagram of a seventh embodiment of apparatus for applying dry lubricant according to the invention and adapted to apply lubricant to a developing sleeve.

FIG. 18 is a schematic block diagram of an eighth embodiment of apparatus for applying dry lubricant according to the invention and adapted to apply lubricant to a photosensitive drum.

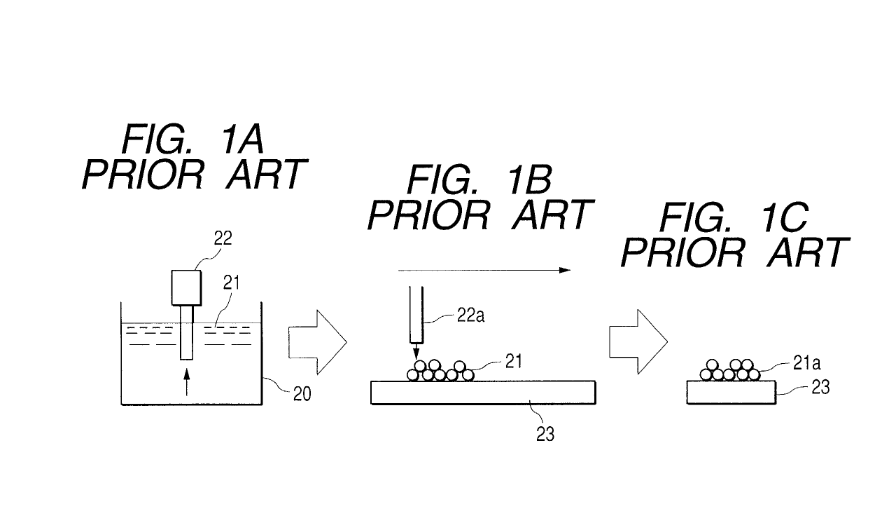

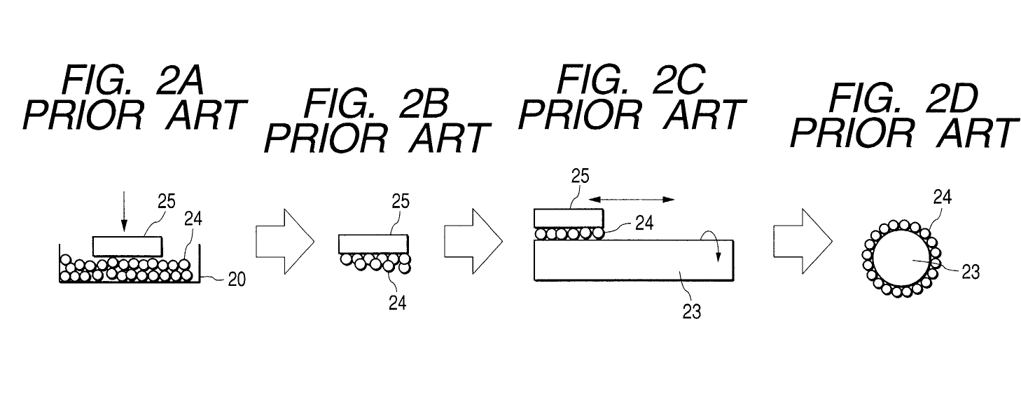

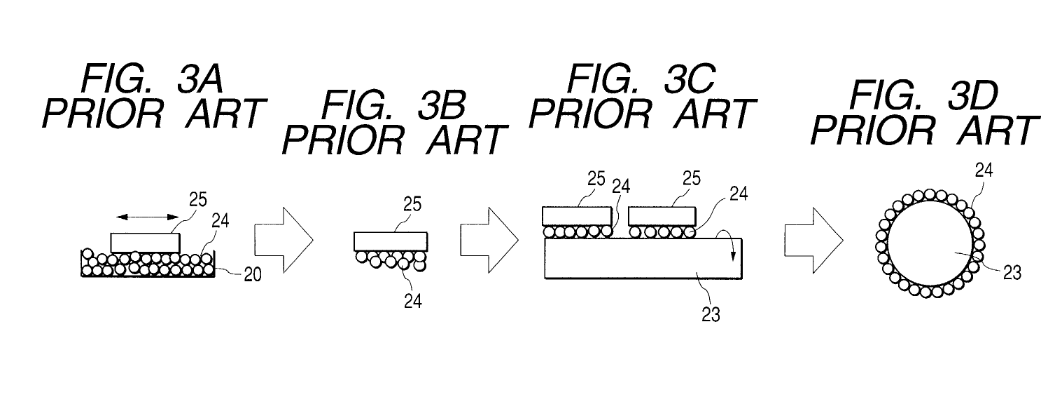

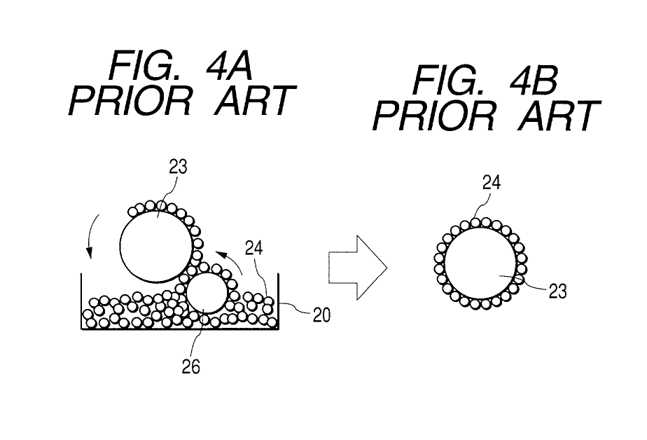

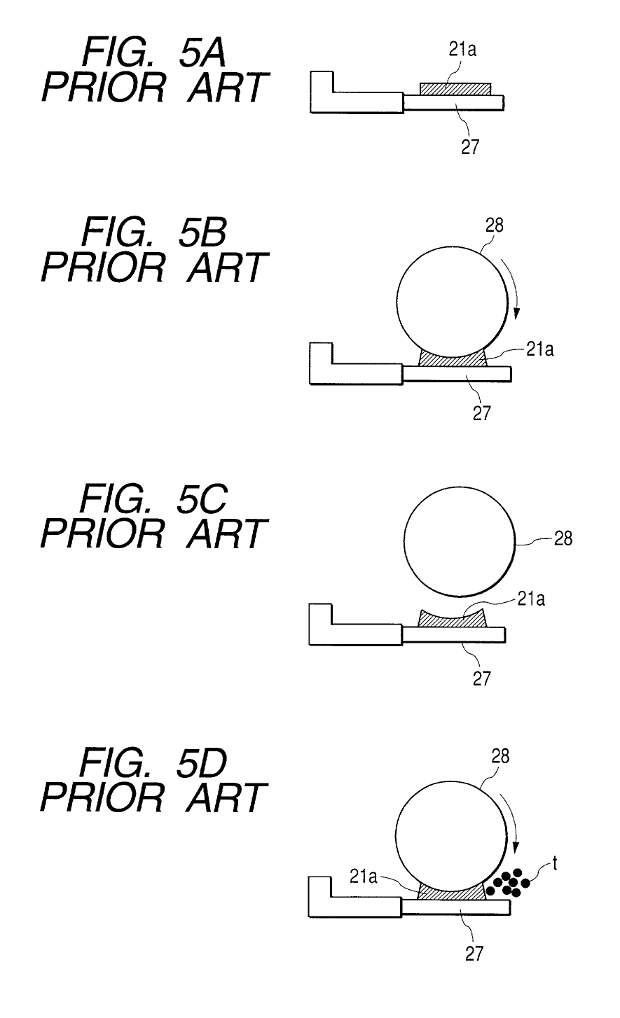

### DESCRIPTION OF THE PREFERRED EMBODIMENTS

Now, the present invention will be described in greater detail by referring to the accompanying drawings that illustrate preferred embodiments of the invention.

<Embodiment 1>

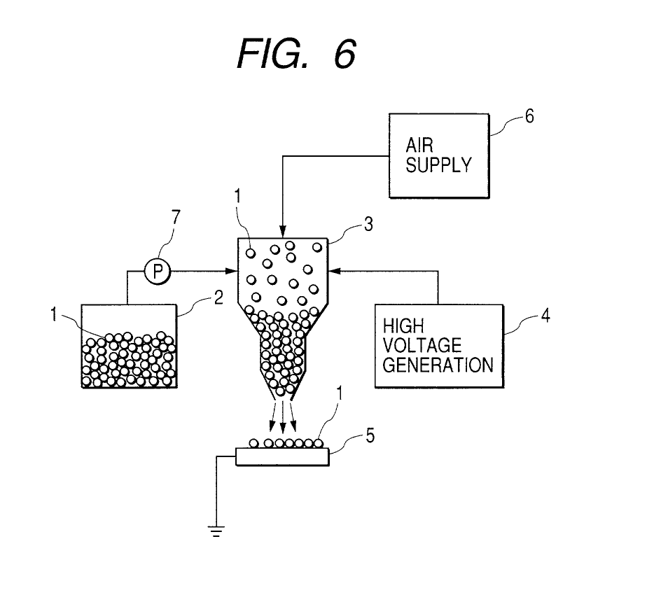

FIG. 6 is a schematic block diagram of a first embodiment of apparatus for applying dry lubricant according to the invention. Referring to FIG. 6, the apparatus for applying dry lubricant comprises a tank 2 filled with dry lubricant 1, a container 3 containing dry lubricant, a high voltage generating unit 4 connected to the container 3 and adapted to apply a high voltage to the dry lubricant 1 in the container 3 and an air supply unit 6 for ejecting the dry lubricant 1 electrically charged by the high voltage that is applied from the high voltage generating unit 4 toward an object of application 5. Note that the container 3 and the air supply unit 6 constitute a dry lubricant ejecting device. The object of application 5 is grounded.

Examples of dry lubricant 1 that can be used for the purpose of the invention include TOSPEARL (tradename: available from GE Toshiba Silicones Co., Ltd.) and SEFBON (tradename: available from Central Glass Co., Ltd.). Preferably, the dry lubricant 1 shows an average grain diameter between 0.4 μm and 25 μm.

Now, a method for applying dry lubricant by means of this embodiment of apparatus for applying dry lubricant according to the invention will be described below.

To begin with, dry lubricant 1 is drawn up from the tank 2 filled with dry lubricant 1 by means of a pump 7. The drawn up dry lubricant 1 is then supplied into the container 3, to which the high voltage generating unit 4 and the air supply unit 6 are connected. The dry lubricant 1 fed to the container 3 is electrically charged by the high voltage applied to the container 3 from the high voltage generating unit 4. The electric charge of the dry lubricant 1 can be controlled by controlling the voltage applied to the container 3 from the high voltage generating unit 4.

Then, the electrically charged dry lubricant 1 is ejected onto an object of application 5 from the opening of the container 3 by dry air fed from the air supply unit 6. The object of application 5 may typically be the sliding member (the developing agent recovering blade or the developing blade) of an image forming apparatus.

At this time, it is important that the dry lubricant 1 ejected from the container 3 is electrically charged to a sufficient level by the high voltage applied from the high voltage generating unit 4. It is also important that the air supply unit 6 supplies sufficiently dried air in order to maintain the dry lubricant 1 to be electrically charged on a stable basis.

As the dry lubricant 1 that is electrically charged to a sufficient level is ejected onto the surface of the object of application 5, the object of application 5 comes to show a potential inverted relative to the dry lubricant 1 and give rise to a potential difference between the object of application 5 and the dry lubricant 1. Since the object of application 5 is grounded, it shows a uniform surface potential.

Thus, the ejected dry lubricant 1 is electrostatically adsorbed to the surface of the object of application 5 because of the potential difference so that consequently the dry lubricant 1 is applied (adheres) uniformly to the surface of the object of application 5. As pointed out earlier, the thickness of the applied layer of dry lubricant 1 on the surface of the object of application 5 and the rate at which the dry lubricant 1 is applied onto the surface of the object of application 5 can be controlled by controlling the electric charge of the dry lubricant 1.

With this embodiment of method for applying dry lubricant according to the invention, as the dry lubricant 1 is directly charged with electricity by applying a voltage thereto, the entire dry lubricant 1 in the container 3 is sufficiently charged with electricity and hence satisfactorily fixed to the surface of the object of application 5. Therefore, the dry lubricant 1 applied to the object of application 5 is reliably prevented from coming off.

Additionally, with this embodiment of method for applying dry lubricant according to the invention, as the electrically charged dry lubricant 1 is forcibly ejected by air, the dry lubricant 1 can be applied uniformly onto the surface of the object of application 5 in a non-contact manner.

Still additionally, since this embodiment of method for applying dry lubricant according to the invention does not use liquid lubricant, it is free from the above identified problems relating to conventional methods for applying liquid lubricant to consequently improve the environment of the operation of applying lubricant.

<Embodiment 2>

This embodiment is adapted to apply dry lubricant to the developing sleeve to be used with an electrophotographic image forming apparatus. Firstly, the configuration of such an image forming apparatus will be described.

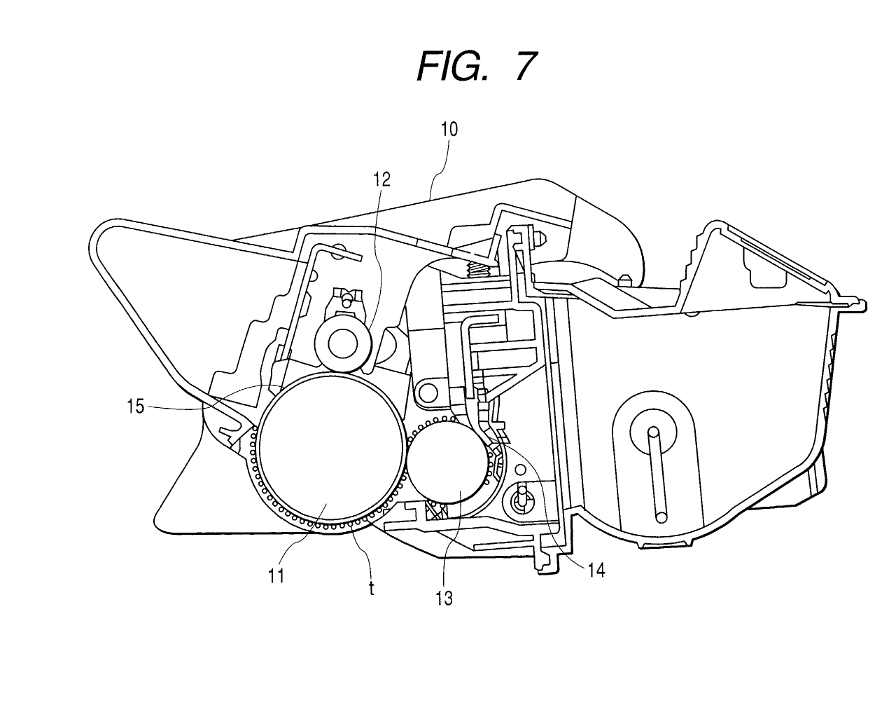

FIG. 7 is a schematic cross sectional view of a process cartridge 10 that can be removably fitted to an electrophotographic image forming apparatus, which may be a copying machine based on electrophotography, a printer or a facsimile machine. As shown in FIG. 7, the cartridge 10 comprises a photosensitive drum 11, an electric charger/roller 12, a developing sleeve 13, a developing blade 14, a developing agent recovering blade 15 and so on. The developing blade 14 is made to abut and slide on the developing sleeve 13 in order to control the thickness of the layer of the developing agent t adhering to the surface of the developing sleeve 13, whereas the developing agent recovering blade 15 is made to abut and slide on the photosensitive drum 11 in order to remove the residual toner remaining on the photosensitive drum 11 after an image transfer operation.

With an image forming apparatus equipped with such a process cartridge 10, the surface of the photosensitive drum 11 is uniformly charged with electricity by the electric charger/roller 12 that is biased by an electric charge and the electrically charged surface of the photosensitive drum 11 is exposed to light by means of an exposure unit (not shown) to form an electrostatic latent image. Then, the electrostatic latent image is developed to a toner image by means of the developing agent t adhering to the developing sleeve 13 of the developing unit and the toner image is transferred onto an image receiving member (not shown) such as a sheet of paper by means of a transfer means (not shown). Thereafter, the transferred toner image is thermally fixed by means of a fixing unit (not shown) and output. The residual toner remaining on the surface of the photosensitive drum 1 after the transfer operation is removed and recovered by the developing agent recovering blade 15.

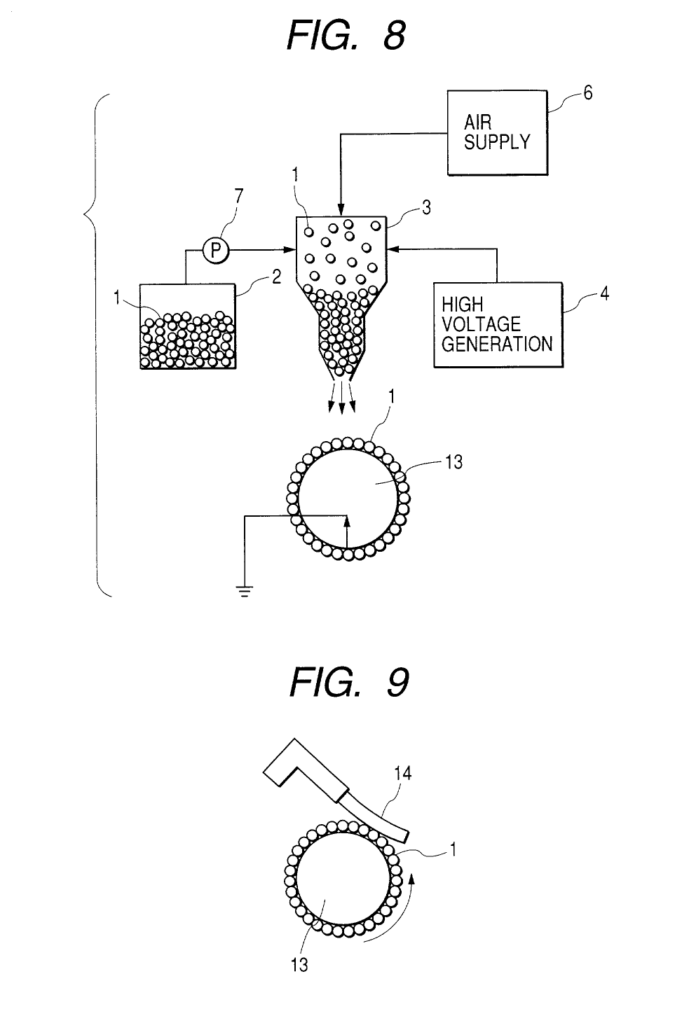

Now, a method for applying dry lubricant by means of this embodiment of apparatus for applying dry lubricant onto the surface of a developing sleeve 13 according to the invention will be described below by referring to FIG. 8.

It will be appreciated that the embodiment of FIG. 8 is identical with Embodiment 1 of FIG. 6 except that the object of application of Embodiment 1 is the developing sleeve 13 in this embodiment. Therefore, in FIG. 8, the components that are same as those of FIG. 6 are denoted respectively by the same reference symbols.

In this embodiment, the developing sleeve 13 is grounded at the surface thereof where the sliding blade 14 slides and contacts and driven to rotate at a predetermined constant peripheral speed. Then, the dry lubricant 1 is drawn up from the tank 2 filled with dry lubricant 1 by means of a pump 7. The drawn up dry lubricant 1 is then supplied into the container 3, to which the high voltage generating unit 4 and the air supply unit 6 are connected. The dry lubricant 1 fed to the container 3 is electrically charged by the high voltage applied to the container 3 from the high voltage generating unit 4. The electric charge of the dry lubricant 1 can be controlled by controlling the voltage applied to the container 3 from the high voltage generating unit 4.

Then, the electrically charged dry lubricant 1 is ejected onto the developing sleeve 13 that is rotating from the opening of the container 3 by dry air fed from the air supply unit 6.

At this time, it is important that the dry lubricant 1 ejected from the container 3 is electrically charged to a sufficient level by the high voltage applied from the high voltage generating unit 4. It is also important that the air supply unit 6 supplies sufficiently dried air in order to maintain the dry lubricant 1 to be electrically charged on a stable basis.

As the dry lubricant 1 that is electrically charged to a sufficient level is ejected onto the surface of the developing sleeve 13, the developing sleeve 13 comes to show a potential inverted relative to the dry lubricant 1 and give rise to a potential difference between the developing sleeve 13 and the dry lubricant 1. Since the developing sleeve 13 is grounded, it shows a uniform surface potential.

Thus, the ejected dry lubricant 1 is electrostatically adsorbed to the surface of the developing sleeve 13 because of the potential difference so that consequently the dry lubricant 1 is applied (adheres) uniformly to the surface of the developing sleeve 13. As pointed out earlier, the thickness of the applied layer of dry lubricant 1 on the surface of the developing sleeve 13 and the rate at which the dry lubricant 1 is applied onto the surface of the developing sleeve 13 can be controlled by controlling the electric charge of the dry lubricant 1.

Therefore, this embodiment of the invention provides the advantages same as those of Embodiment 1. Since the developing blade 14 is made to abut and slide on the developing sleeve 13 to the surface of which the dry lubricant 1 is applied (adsorbed) uniformly as shown in FIG. 9, the embodiment can effectively prevent the above pointed out problems such as a warped developing blade 14 and a scraped contact area of the developing sleeve 13.

<Embodiment 3>

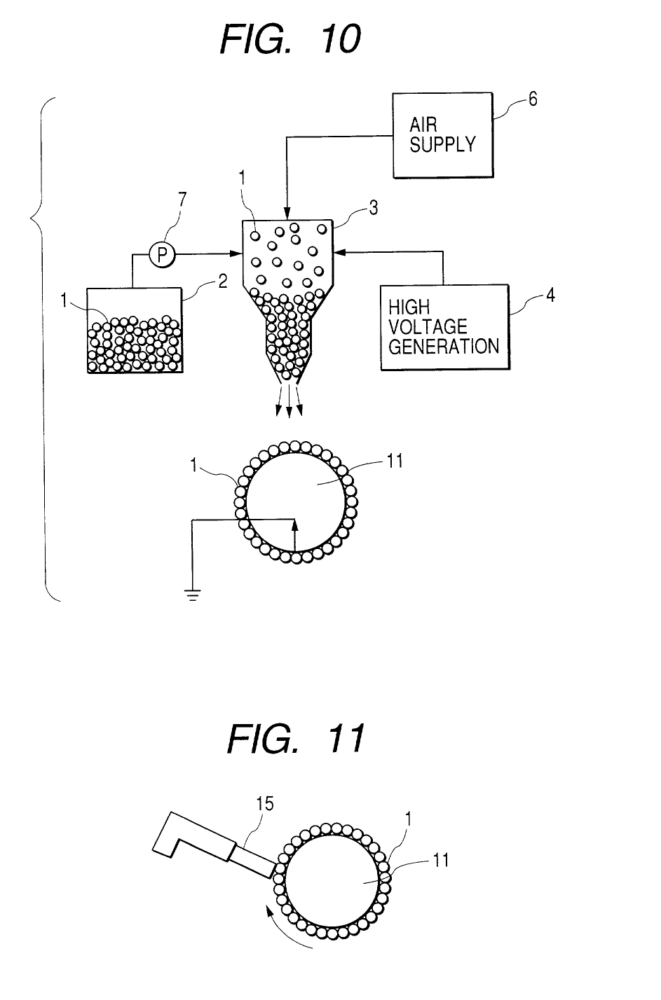

While Embodiment 2 is adapted to apply dry lubricant onto the surface of the developing sleeve 13, this embodiment is adapted to apply dry lubricant onto the surface of the photosensitive drum 11 of an image forming apparatus. This embodiment will now be described by referring to FIG. 10.

It will be appreciated that the embodiment of FIG. 10 is identical with Embodiment 1 of FIG. 6 except that the object of application of Embodiment 1 is the photosensitive drum 13 in this embodiment. Therefore, in FIG. 10, the components that are same as those of FIG. 6 are denoted respectively by the same reference symbols.

In this embodiment, the photosensitive drum 11 is grounded at the surface thereof where the developing agent recovering blade 15 slides and contacts and driven to rotate at a predetermined constant peripheral speed. Then, the dry lubricant 1 is drawn up from the tank 2 filled with dry lubricant 1 by means of a pump 7. The drawn up dry lubricant 1 is then supplied into the container 3, to which the high voltage generating unit 4 and the air supply unit 6 are connected. The dry lubricant 1 fed to the container 3 is electrically charged by the high voltage applied to the container 3 from the high voltage generating unit 4. The electric charge of the dry lubricant 1 can be controlled by controlling the voltage applied to the container 3 from the high voltage generating unit 4.

Then, the electrically charged dry lubricant 1 is ejected onto the photosensitive drum 11 that is rotating from the opening of the container 3 by dry air fed from the air supply unit 6.

At this time, it is important that the dry lubricant 1 ejected from the container 3 is electrically charged to a sufficient level by the high voltage applied from the high voltage generating unit 4. It is also important that the air supply unit 6 supplies sufficiently dried air in order to maintain the dry lubricant 1 to be electrically charged on a stable basis.

As the dry lubricant 1 that is electrically charged to a sufficient level is ejected onto the surface of the photosensitive drum 11, the photosensitive drum 11 comes to show a potential inverted relative to the dry lubricant 1 and give rise to a potential difference between the photosensitive drum 11 and the dry lubricant 1. Since the photosensitive drum 11 is grounded, it shows a uniform surface potential.

Thus, the ejected dry lubricant 1 is electrostatically adsorbed to the surface of the photosensitive drum 11 because of the potential difference so that consequently the dry lubricant 1 is applied (adheres) uniformly to the surface of the photosensitive drum 11. As pointed out earlier, the thickness of the applied layer of dry lubricant 1 on the surface of the photosensitive drum 11 and the rate at which the dry lubricant 1 is applied onto the surface of the photosensitive drum 11 can be controlled by controlling the electric charge of the dry lubricant

Therefore, this embodiment of the invention provides the advantages same as those of Embodiment 1. Since the developing agent recovering blade 15 is made to abut and slide on the photosensitive drum 11 to the surface of which the dry lubricant 1 is applied (adsorbed) uniformly as shown in FIG. 11, the embodiment can effectively prevent the above pointed out problems such as a warped developing agent recovering blade 15 and a dented contact surface of the photosensitive drum 11.

<Embodiment 4>

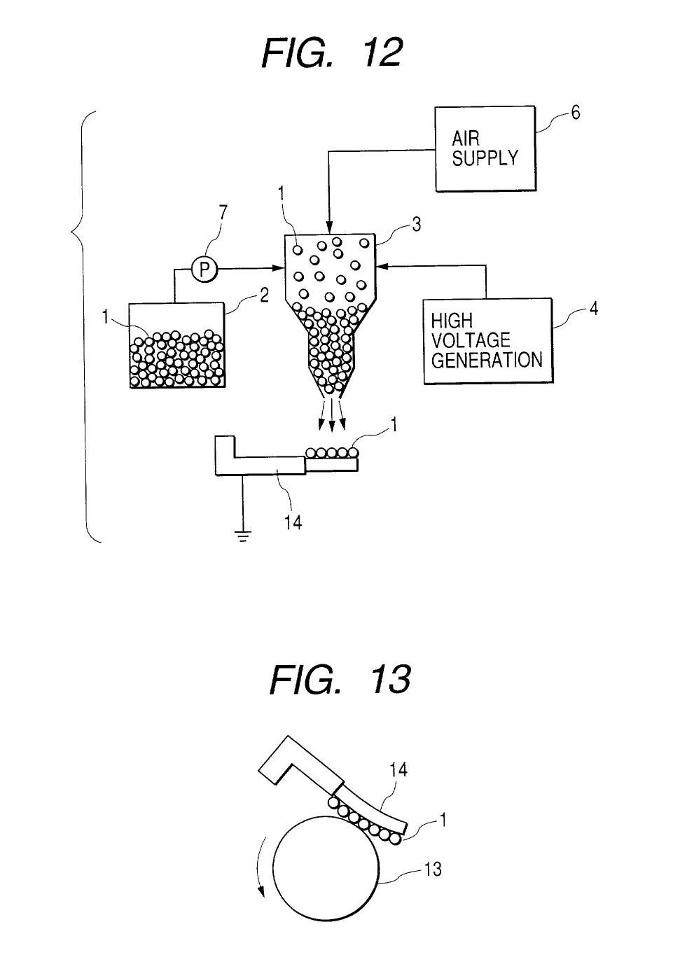

While Embodiment 2 is adapted to apply dry lubricant onto the surface of the developing sleeve 13, this embodiment is adapted to apply dry lubricant onto the surface of the developing blade 14 of an image forming apparatus. This embodiment will now be described by referring to FIG. 12.

It will be appreciated that the embodiment of FIG. 12 is identical with Embodiment 1 of FIG. 6 except that the object of application of Embodiment 1 is the developing blade 14 in this embodiment. Therefore, in FIG. 12, the components that are same as those of FIG. 6 are denoted respectively by the same reference symbols.

In this embodiment, the developing blade 14 is grounded. Then, the dry lubricant 1 is drawn up from the tank 2 filled with dry lubricant 1 by means of a pump 7. The drawn up dry lubricant 1 is then supplied into the container 3, to which the high voltage generating unit 4 and the air supply unit 6 are connected. The dry lubricant 1 fed to the container 3 is electrically charged by the high voltage applied to the container 3 from the high voltage generating unit 4. The electric charge of the dry lubricant 1 can be controlled by controlling the voltage applied to the container 3 from the high voltage generating unit 4.

Then, the electrically charged dry lubricant 1 is ejected onto the developing blade 14 from the opening of the container 3 by dry air fed from the air supply unit 6.

At this time, it is important that the dry lubricant 1 ejected from the container 3 is electrically charged to a sufficient level by the high voltage applied from the high voltage generating unit 4. It is also important that the air supply unit 6 supplies sufficiently dried air in order to maintain the dry lubricant 1 to be electrically charged on a stable basis.

As the dry lubricant 1 that is electrically charged to a sufficient level is ejected onto the surface of the developing blade 14, the developing blade 14 comes to show a potential inverted relative to the dry lubricant 1 and give rise to a potential difference between the developing blade 14 and the dry lubricant 1. Since the developing bale 14 is grounded, it shows a uniform surface potential.

Thus, the ejected dry lubricant 1 is electrostatically adsorbed to the surface of the developing blade 14 because of the potential difference so that consequently the dry lubricant 1 is applied (adheres) uniformly to the surface of the developing blade 14. As pointed out earlier, the thickness of the applied layer of dry lubricant 1 on the surface of the developing blade 14 and the rate at which the dry lubricant 1 is applied onto the surface of the developing blade 14 can be controlled by controlling the electric charge of the dry lubricant 1.

Therefore, this embodiment of the invention provides the advantages same as those of Embodiment 1. Since the developing sleeve 13 is made to abut and slide on the developing blade 14 to the surface of which the dry lubricant 1 is applied (adsorbed) uniformly as shown in FIG. 13, the embodiment can effectively prevent the above pointed out problems such as a warped developing blade 14 and a scraped contact area of the developing sleeve 13.

<Embodiment 5>

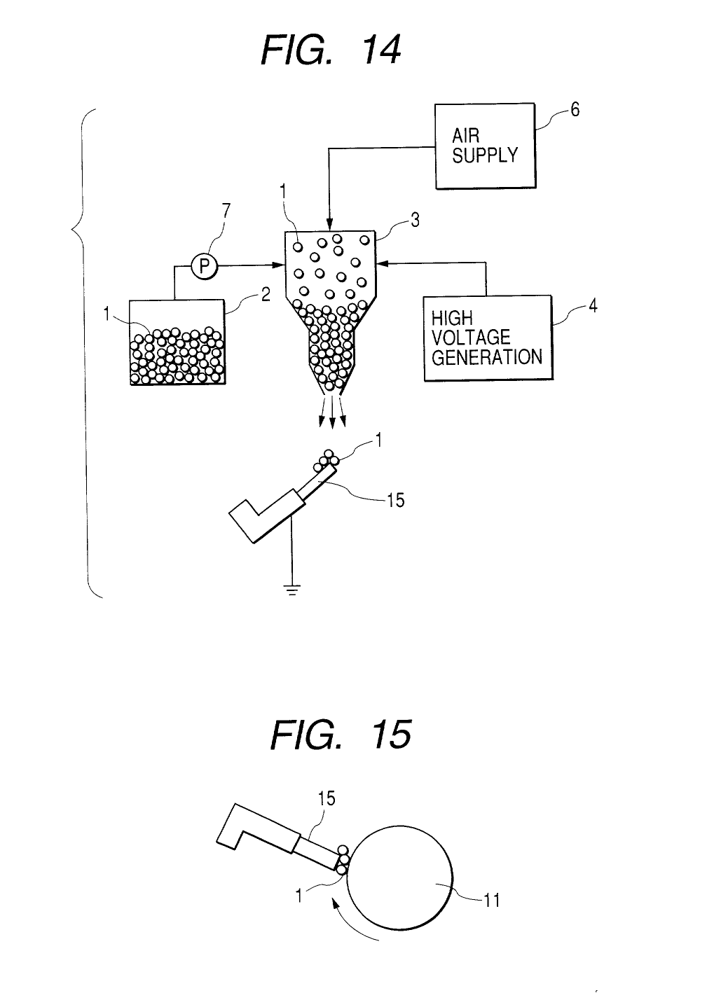

While Embodiment 4 is adapted to apply dry lubricant onto the surface of the developing blade 14, this embodiment is adapted to apply dry lubricant onto the surface of the developing agent recovering blade 15 of an image forming apparatus. This embodiment will now be described by referring to FIG. 14.

It will be appreciated that the embodiment of FIG. 14 is identical with Embodiment 1 of FIG. 6 except that the object of application of Embodiment 1 is the developing agent recovering blade 15 in this embodiment. Therefore, in FIG. 14, the components that are same as those of FIG. 6 are denoted respectively by the same reference symbols.

In this embodiment, the developing agent recovering blade 15 is grounded. Then, the dry lubricant 1 is drawn up from the tank 2 filled with dry lubricant 1 by means of a pump 7. The drawn up dry lubricant 1 is then supplied into the container 3, to which the high voltage generating unit 4 and the air supply unit 6 are connected. The dry lubricant 1 fed to the container 3 is electrically charged by the high voltage applied to the container 3 from the high voltage generating unit 4. The electric charge of the dry lubricant 1 can be controlled by controlling the voltage applied to the container 3 from the high voltage generating unit 4.

Then, the electrically charged dry lubricant 1 is ejected onto the developing agent recovering blade 15 from the opening of the container 3 by dry air fed from the air supply unit 6.

At this time, it is important that the dry lubricant 1 ejected from the container 3 is electrically charged to a sufficient level by the high voltage applied from the high voltage generating unit 4. It is also important that the air supply unit 6 supplies sufficiently dried air in order to maintain the dry lubricant 1 to be electrically charged on a stable basis.

As the dry lubricant 1 that is electrically charged to a sufficient level is ejected onto the surface of the developing agent recovering blade 15, the developing agent recovering blade 15 comes to show a potential inverted relative to the dry lubricant 1 and give rise to a potential difference between the developing agent recovering blade 15 and the dry lubricant 1. Since the developing agent recovering blade 15 is grounded, it shows a uniform surface potential.

Thus, the ejected dry lubricant 1 is electrostatically adsorbed to the surface of the developing agent recovering blade 15 because of the potential difference so that consequently the dry lubricant 1 is applied (adheres) uniformly to the surface of the developing agent recovering blade 15. As pointed out earlier, the thickness of the applied layer of dry lubricant 1 on the surface of the developing agent recovering blade 15 and the rate at which the dry lubricant 1 is applied onto the surface of the developing agent recovering blade 15 can be controlled by controlling the electric charge of the dry lubricant 1.

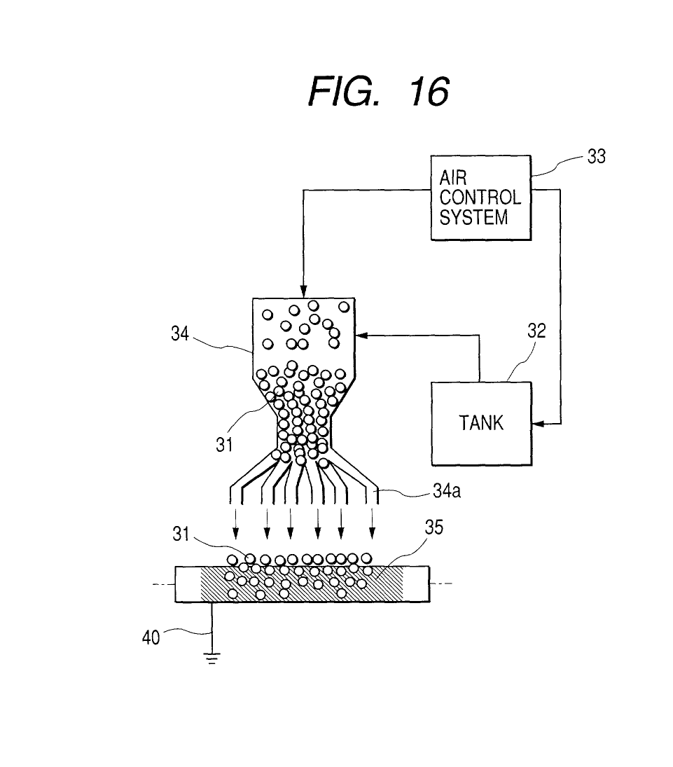

Therefore, this embodiment of the invention provides the advantages same as those of Embodiment 1. Since the photosensitive drum 11 is made to abut and slide on the developing agent recovering blade 15 to the surface of which the dry lubricant 1 is applied (adsorbed) uniformly as shown in FIG. 15, the embodiment can effectively prevent the above pointed out problems such as a warped developing agent recovering blade 15 and a dented contact surface of the photosensitive drum 11.

In the above described Embodiments 1 through 5, a high voltage is applied to the container containing dry lubricant from the high voltage generating unit to charge the dry lubricant with electricity. It is also possible to charge dry lubricant with electricity by friction, using a friction charge gun for the container without using a high voltage generating unit. Such embodiments will be described below.

<Embodiment 6>

FIG. 16 is a schematic block diagram of Embodiment 6 which is an apparatus for applying powdery dry lubricant. As shown in FIG. 16, this embodiment of apparatus for applying dry lubricant comprises a tank 32 filled with dry lubricant 31 that can be electrically charged by friction, a friction charge gun 34 for electrically charging the dry lubricant 31 fed from the tank 32 by friction and discharging the electrically charged dry lubricant 31 to an object of application 35 in a non-contact fashion and an air control system 33 for supplying air to the tank 32 and the friction charge gun 34. The friction charge gun 34 has an opening and nozzles 34a are arranged at the opening.

This method for applying dry lubricant that is used with this embodiment of apparatus for applying dry lubricant comprises a step of supplying air from the air control system 33 to the tank 32 filled with dry lubricant 31 that can be electrically charged by friction and then supplying dry lubricant 31 from the tank 32 to the friction charge gun 34, a step of electrically charging the dry lubricant 31 fed to the friction charge gun 34 by friction within the friction charge gun 34, a step of supplying air from the air control system 33 to the friction charge gun 34 and ejecting the dry lubricant 31 electrically charged by friction from the friction charge gun toward the object of application 35 held in an non-contact state relative to the friction charge gun 34 and grounded and a step of causing the dry lubricant 31 to adhere to the object of application 35 by the relative potential difference between the dry lubricant 31 electrically charged by friction and the grounded object of application 35. As a result of the above steps, the dry lubricant 31 is applied to the object of application 35.

Known liquid lubricating agents are prepared by dispersing dry lubricant into solvent (inert liquid, organic solvent). Such liquid lubricating agents have a major disadvantage that the dry lubricant immersed in the solvent expands when it is held in the solvent for a long time. Therefore, after recovering such liquid lubricant, the dry lubricant contained in the solvent has to be separated from the latter and dried before it is reused. If the dry lubricant is immersed in the solvent too long, it expands excessively and can no longer be reused.

Additionally, the solvent separated from the dry lubricant of liquid lubricant also has to be recovered for reuse. When recovering the solvent, an apparatus for heating, gasifying and condensing the solvent is required in order to completely eliminate the residual dry lubricant remaining in the separated solvent.

In the case of this embodiment, dry lubricant is applied alone so that it is possible to suck the dry lubricant that is left unapplied and return it to the tank simply after causing it to pass through a mesh for the purpose of recovery and reuse. The apparatus for separating the dry lubricant contained in liquid lubricant and drying it and heating, gasifying and condensing the solvent as described above is very costly if compared with the arrangement of this embodiment for sucking dry lubricant and causing it to pass through a mesh. In other words, this embodiment can recover and reuse dry lubricant at low cost.

The inside of the friction charge gun 34 is surface-treated by fluorine type resin so that the dry lubricant 31 fed to the friction charge gun 34 becomes electrically charged as it is made to collide with the inner surface at high speed repeatedly. The electric charge of the dry lubricant 31 is increased by raising the speed at which the dry lubricant 31 is made to pass inside the friction charge gun 34.

Then, the dry lubricant 31 that is electrically charged by friction is ejected toward the object of application 35 from the friction charge gun 34 by means of air supplied from the air control system 33. It is important that the dry lubricant 31 ejected from the friction charge gun is electrically charged to a sufficient extent within the friction charge gun 34.

The relative potential difference between the dry lubricant 31 and the object of application 35 will be small and hence the dry lubricant 31 will not be electrically satisfactorily fixed so that it will easily come off if the dry lubricant 31 is not electrically charged to a sufficient extent. Additionally, dry lubricant that is not electrically sufficiently charged will hardly get to the rear surface of the object of application 35.

The dry lubricant 31 that is electrically charged within the friction charge gun 34 holds its electric charge to a sufficient extent after it is applied to the object of application 35. Therefore, the level of the electric charge of the dry lubricant 31 can be determined by observing the surface potential of the object of application 35 where the applied dry lubricant 31 is fixed.

It is also important to supply sufficiently dried air from the air control system 33 in order to eject dry lubricant 31 from the friction charge gun 34 for the purpose of causing the ejected dry lubricant 31 to maintain its electric charge on a stable basis.

For example, such dry air can be obtained by causing the captured ambient air to pass through an air drier. Additionally, an oil filter is arranged both upstream and downstream of the air drier in order to eliminate any oil and water coming from the compressor.

Dry air is used for the purpose of the invention because the dry lubricant 31 is not electrically charged by friction to a satisfactory level if the air carrying the dry lubricant 31 contains moisture to a significant extent. Oil filters are used because otherwise oil and water can enter the inside of the friction charge gun 34 and the friction charge gun 34 contaminated with such substances in the inside shows a reduced frictional force.

Additionally, the object of application 35 is made to show a uniform surface potential as it is grounded by way of a grounding terminal 40 so that the object of application 35 shows a potential inverted relative to the dry lubricant 31 and gives rise to a potential difference between the object of application 35 and the dry lubricant 31. Due to the potential difference, the dry lubricant 31 is adsorbed to the object of application 35 and adhered (fixed) to the latter. Thus, as a result of ejecting electrically sufficiently charged dry lubricant 31 to an object of application 35 having a uniform surface potential, the dry lubricant 31 adhering to the object of application 35 is satisfactorily fixed and prevented from coming off from the latter.

The air control system 33 is adapted to control the rate at which air is supplied to the friction charge gun 34. Air is supplied to the friction charge gun 34 at a constant rate so that dry lubricant 31 may be ejected toward the object of application 35 also at a constant rate. As a result, dry lubricant 31 is ejected from the friction charge gun 34 toward the object of application 35 always at a constant rate so that a predetermined amount of dry lubricant 31 is reliably applied onto the object of application 35 and the object of application 35 reliably carries a layer of the applied dry lubricant having a predetermined thickness.

Additionally, the thickness of the layer of the applied dry lubricant formed on the object of application 35 can be controlled by controlling the rate at which air is fed from the air control system 33 to the friction charge gun 34.

<Embodiment 7>

This embodiment is designed to apply dry lubricant onto a developing sleeve by using an apparatus for applying dry lubricant having a configuration similar to that of Embodiment 6 and the above described method in order to prevent a warped developing blade and a scraped contact area of the developing sleeve from taking place when the developing blade is pressed against the developing sleeve operating as sliding member (object of application).

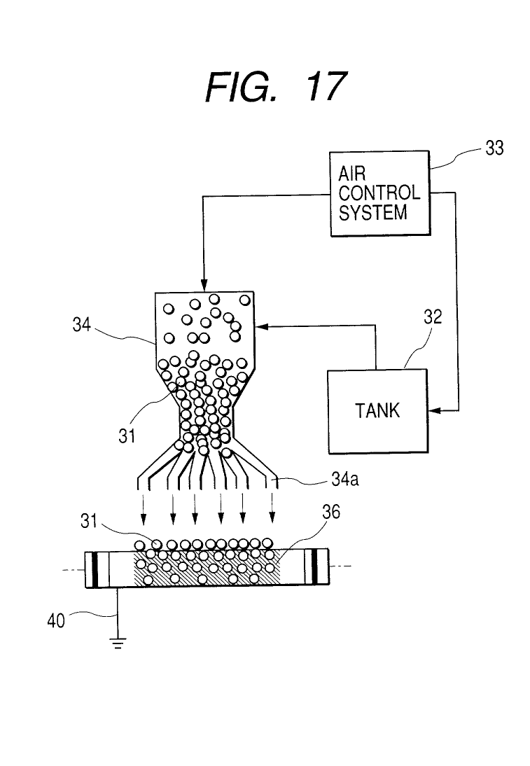

FIG. 17 is a schematic block diagram of Embodiment 7 of apparatus for applying dry lubricant according to the invention and adapted to apply lubricant to a developing sleeve. In FIG. 17, the components same as or similar to those of FIG. 16 are denoted respectively by the same reference symbols.

The developing sleeve 36 is grounded by way of the grounding terminal 40 and rigidly secured in order to uniformly apply dry lubricant in a non-contact fashion. The developing sleeve 36 is grounded in order to make it show a uniform surface potential so that the dry lubricant applied thereto may be satisfactorily fixed and the potential difference between the electrically sufficiently charged dry lubricant 31 and the surface of the developing sleeve 36 may be held to a constant level.

Then, air is supplied from the air control system 33 to the tank 32 filled with dry lubricant 31 and dry lubricant 31 is supplied from the tank 32 to the friction charge gun 34, to which the air control system 33 is connected. The dry lubricant 31 fed to the friction charge gun 34 is electrically charged by friction within the friction charge gun 34.

As pointed out above, the dry lubricant 31 ejected from the friction charge gun 34 is electrically sufficiently charged within the friction charge gun 34 so that it may be fixed well to the surface of the developing sleeve 36.

Dry lubricant 31 used in this embodiment is in a fine particle state. More specifically, TOSPEARL (tradename: available from GE Toshiba Silicones Co., Ltd.) supplied in two types, one with an average particle diameter between 8 μm and 25 μm and the other with an average particle diameter between 15 μm and 30 μm, may be used. However, Embodiments 6 through 8 are not limited thereto and any powdery dry lubricant 31 that can be electrically charged by friction may be applied to an object of application. For instance, a developing agent (toner) that can be electrically charged by friction may also be used for these embodiments. However, electrically conductive dry lubricating agents showing a low volume resistivity (e.g., CEFBON (tradename: available from Central Glass Co., Ltd.) cannot be applied to an object of application because they are not electrically charged by friction.

Then, as described above, the dry lubricant 31 that is electrically charged by friction is ejected from the friction charge gun 34 toward the developing sleeve 36 that is rigidly secured (or moved at a constant rate) by means of dry air fed from the air control system 33.

The ejected dry lubricant 31 is adsorbed to the surface of the grounded developing sleeve 36 due to the potential difference between them. Then, the developing sleeve to the surface of which the dry lubricant is adsorbed is pressed against the developing blade for operation as described earlier by referring to FIG. 9.

<Embodiment 8>

This embodiment is designed to apply dry lubricant onto a photosensitive drum by using an apparatus for applying dry lubricant having a configuration similar to that of Embodiment 6 and the above described method in order to prevent a warped developing agent recovering blade and a dented contact surface of the photosensitive drum from taking place when the developing agent recovering blade is pressed against the photosensitive drum operating as sliding member (object of application).

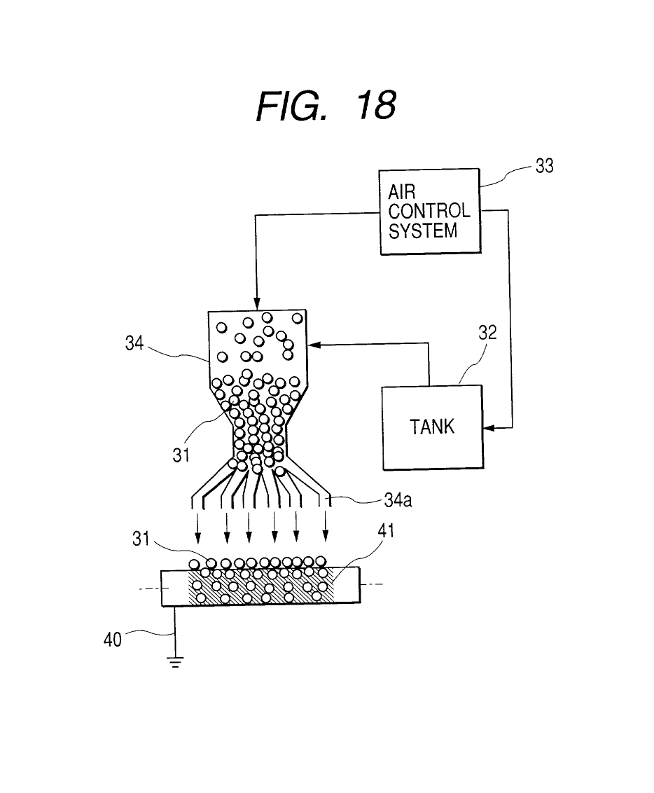

FIG. 18 is a schematic block diagram of Embodiment 8 of apparatus for applying dry lubricant according to the invention and adapted to apply lubricant to a photosensitive drum. In FIG. 18, the components same as or similar to those of FIG. 16 are denoted respectively by the same reference symbols.

The photosensitive drum 41 is grounded by way of the grounding terminal 40 and rigidly secured in order to uniformly apply dry lubricant to the photosensitive drum 41 in a non-contact fashion. The photosensitive drum 41 is grounded in order to make it show a uniform surface potential so that the dry lubricant applied thereto may be satisfactorily fixed and the potential difference between the electrically sufficiently charged dry lubricant 31 and the surface of the photosensitive drum 41 may be held to a constant level.

Then, air is supplied from the air control system 33 to the tank 32 filled with dry lubricant 31 and dry lubricant 31 is supplied from the tank 32 to the friction charge gun 34, to which the air control system 33 is connected. The dry lubricant 31 fed to the friction charge gun 34 is electrically charged by friction within the friction charge gun 34. As pointed out above, the dry lubricant 31 ejected from the friction charge gun 34 is electrically sufficiently charged within the friction charge gun 34 so that it may be fixed well to the surface of the photosensitive drum 41.

Dry lubricant 31 used in this embodiment is in a fine particle state. More specifically, TOSPEARL (tradename: available from GE Toshiba Silicones Co., Ltd.) with an average particle diameter between 0.4 μm and 1.0 μm may be used. However, Embodiments 6 through 8 are not limited thereto as pointed above.

Then, as described above, the dry lubricant 31 that is electrically charged by friction is ejected from the friction charge gun 34 toward the photosensitive drum 41 that is rigidly secured (or moved at a constant rate) by means of dry air fed from the air control system 33.

The ejected dry lubricant 31 is adsorbed to the surface of the grounded photosensitive drum 41 due to the potential difference between them. Then, the photosensitive drum to the surface of which the dry lubricant is adsorbed is pressed against the developing agent recovering blade for operation as described earlier by referring to FIG. 11.

As described above, with each of Embodiments 6 through 8, since dry lubricant 31 is ejected from the friction charge gun 34 toward the developing sleeve 36 or the photosensitive drum 41 that is held out of contact from the friction charge gun 34, the developing sleeve 36 or the photosensitive drum 41 is prevented from being damaged, if slightly, when applying dry lubricant 31 to it.

Additionally, as pointed out above, since the particles of dry lubricant 31 in the friction charge gun 34 are electrically sufficiently charged by friction within the friction charge gun 34, they can be made to be fixed well to the developing sleeve 36 or the photosensitive drum 41.

Still additionally, as described above, since the rate at which air is supplied from the air control system 33 to the friction charge gun 34 can be controlled and dry lubricant 31 is ejected toward the developing sleeve 36 or the photosensitive drum 41 at a constant rate, the volume of the dry lubricant that is applied to the developing sleeve 36 or the photosensitive drum 41 can be held to a constant level. Furthermore, since the thickness of the layer of dry lubricant formed on the developing sleeve 36 or the photosensitive drum 41 is controlled by controlling the rate at which air is supplied from the air control system 33 to the friction charge gun 34, the layer of the dry lubricant applied to the developing sleeve 36 or the photosensitive drum 41 can be made to show a uniform thickness.

The use of dry lubricant can eliminate the formation of layers of lubricant that is produced when liquid lubricant is used so that no ‘ruts’ is formed in the lubricant on the developing sleeve 36 or the photosensitive drum 41 to improve the quality of the produced image.

The nozzles 34a of the friction charge gun 34 for ejecting lubricant are arranged over the entire longitudinal span of the developing sleeve 36 or the photosensitive drum 41 as shown in FIG. 17 or 18, whichever appropriate, in each of Embodiments 6 through 8. As a matter of fact, a large number of nozzles 34 are arranged in parallel with the object of application in order to uniformly apply dry lubricant 31 onto the developing sleeve 36 or the photosensitive drum 41 that is rigidly secured. By arranging nozzles in this way, the distance between the nozzles and the object of application can be held to a uniform and constant value if the object of application has a great length.

Finally, the front ends of the nozzles are arranged like those of a shower head to spray and apply dry lubricant uniformly. However, the present invention is by no means limited thereto. Alternatively, the friction charge gun 34 having nozzles 34a may be rigidly secured and the developing sleeve 36 or the photosensitive drum 41 may be moved at a constant rate to spray and apply dry lubricant uniformly.

What is claimed is:

1. A method for applying dry lubricant comprising the steps of:
charging the dry lubricant contained in a container having an opening with electricity;
supplying air to said container and ejecting the electrically charged dry lubricant from said opening toward an object of application grounded and separated from said opening by a predetermined distance; and
causing the dry lubricant ejected from said opening to be adsorbed by said object of application by means of electrostatic force.

2. A method according to claim 1, wherein
is said step of charging the dry lubricant with electricity comprises a step of applying a voltage to said container.

3. A method according to claim 1, wherein
said container comprises a friction charge gun and said dry lubricant is electrically charged by friction.

4. A method according to claim 1, wherein
said object of application comprises a developing sleeve to be used for an electrophotographic image forming apparatus.

5. A method according to claim 4, wherein
the dry lubricant ejected from said opening is caused to be adsorbed uniformly to the surface of the developing sleeve, while rotating said developing sleeve.

6. A method according to claim 1, wherein
said object of application comprises a photosensitive drum to be used for an electrophotographic image forming apparatus.

7. A method according to claim 6, wherein
the dry lubricant ejected from said opening is caused to be adsorbed uniformly to the surface of the photosensitive drum, while rotating said photosensitive drum.

8. A method according to claim 1, wherein
said object of application comprises a developing blade to be used for an electrophotographic image forming apparatus.

9. A method according to claim 1, wherein
said object of application comprises a developing agent recovering blade to be used for an electrophotographic image forming apparatus.

10. An apparatus for applying dry lubricant comprising:
a container having an opening and containing dry lubricant;
an electrically charging means for charging the dry lubricant contained in said container with electricity; and
an air supply means for ejecting the electrically charged dry lubricant from said opening toward an object of application grounded and separated from said opening by a predetermined distance by supplying air to said container.

11. An apparatus according to claim 10, wherein
said electrically charging means comprises a power source for applying a voltage to said container.

12. An apparatus according to claim 10, wherein
said container comprises a friction charge gun and said dry lubricant is electrically charged by friction.

13. An apparatus according to claim 12, wherein
said friction charge gun is surface-treated in the inside by fluorine type resin so that the dry lubricant fed to the friction charge gun becomes electrically charged as it is made to collide with the inner surface at high speed repeatedly.

14. An apparatus according to claim 10, wherein
said opening of the container comprises a plurality of nozzles arranged in parallel relative to the object of application.

15. An apparatus according to claim 10, wherein
said opening of the container comprises a plurality of nozzles with the front ends thereof arranged like those of a shower head.

16. An apparatus according to claim 10, wherein
said air supply means has a means for controlling the rate of supply of air to said container.

17. An apparatus according to claim 10, wherein
said air supply means comprises an air control system having an air drier for drying the ambient air captured by it and a pair of oil filters arranged respectively at the upstream side and the downstream side of the air drier.

18. An apparatus according to claim 10, wherein
said object of application comprises a developing sleeve to be used for an electrophotographic image forming apparatus and said apparatus further comprises a means for driving said developing sleeve to rotate relative to the dry lubricant ejected from the opening.

19. An apparatus according to claim 10, wherein
said object of application comprises a photosensitive drum to be used for an electrophotographic image forming apparatus and said apparatus further comprises a means for driving said photosensitive drum to rotate relative to the dry lubricant ejected from the opening.

20. An apparatus according to claim 10, further comprising:
a storage tank for storing dry lubricant and a pump for supplying dry lubricant from said storage tank to said container.
